(19) United States
(12) Patent Application Publication
(10) Pub. No.: US 2016/0159392 A1
(43) Pub. Date: Jun. 9, 2016

(54) Lightweight Steering Knuckle Assembly and Method of Manufacturing the Same

(71) Applicant: SHILOH INDUSTRIES, INC., Valley City, OH (US)

(72) Inventor: Bernhard Hoffmann, Davisburg, MI (US)

(21) Appl. No.: 14/905,615

(22) PCT Filed: Aug. 4, 2014
(86) PCT No.: PCT/US2014/049607

§ 371 Date: Jan. 15, 2016

Related U.S. Application Data
(60) Provisional application No. 61/861,548, filed on Aug. 2, 2013.

(51) Int. Cl. B62D 7/18; B22D 19/02; B22D 21/00; B22D 18/04

(52) U.S. Cl. CPC B62D 7/18; B22D 18/04; B22D 19/02; B22D 21/007

(57) ABSTRACT

A steering knuckle assembly that is made of a lightweight material, such as an aluminum-based material, but is strong enough to withstand various induced stresses like those caused during a press-fit installation of a wheel bearing assembly. In one embodiment, the steering knuckle assembly includes a steering knuckle component made of an aluminum-based material that is over-molded or cast around a reinforcing insert made of a stronger ferrous-based material. The reinforcing insert has an inner surface surrounding an opening that is designed to receive a wheel bearing assembly, where the inner surface can be machined before or after the over-molding or casting process.

### REFERENCE TO RELATED APPLICATIONS

This application claims the benefit of U.S. Provisional Ser. No. 61/861,548 filed on Aug. 2, 2013, the entire contents of which are incorporated herein by reference.

### TECHNICAL FIELD

The present disclosure generally relates to steering knuckles for vehicles and, more particularly, to steering knuckles made from light weight materials like aluminum-based materials.

### BACKGROUND

A steering knuckle, sometimes referred to as an upright or wheel carrier, rotatably holds a wheel and tire assembly and is connected to parts of the vehicle suspension and/or steering systems, such as control arms and tie rods. Because of its role in securely maintaining the wheels while the vehicle is being driven, a steering knuckle can be subjected to a number of stresses and forces acting upon it. In addition, some manufacturing processes involve press fitting a wheel bearing assembly into an opening in the steering knuckle that can introduce significant hoop or circumferential stresses in the part.

Traditionally, steering knuckles were made of cast iron or some other material possessing significant strength. These materials, however, are quite heavy and can add a fair amount of weight to the vehicle. Thus, it would be desirable to provide a steering knuckle that is strong enough to withstanding the various stresses and forces acting upon it, yet has a light weight construction in order to improve the fuel economy of the vehicle.

### SUMMARY

According to one aspect, there is a steering knuckle assembly for a vehicle, comprising a steering knuckle component and a reinforcing insert. The steering knuckle component is made of a first metal material and has a body portion and one or more attachment portions. The reinforcing insert is made of a second metal material and has an outer surface, an inner surface and a bearing opening, where the first metal material is lighter than the second metal material and the second metal material is harder than the first metal material. The steering knuckle component is at least partially formed around the reinforcing insert so that the outer surface of the reinforcing insert is encased in the first metal material and the inner surface of the reinforcing insert surrounds the bearing opening and forms a contact surface for a wheel bearing assembly.

According to another aspect, there is provided a method of forming a steering knuckle assembly for a vehicle. The method may comprise the steps of: positioning a reinforcing insert within a mold cavity of a die casting machine; introducing a molten aluminum-based material into the mold cavity of the die casting machine so that the molten material at least partially surrounds the reinforcing insert; applying pressure with the die casting machine to form a composite steering knuckle component with the integrally formed reinforcing insert; and removing the composite steering knuckle component from the die casting machine, wherein the integrally formed reinforcing insert includes an inner surface for receiving a wheel bearing assembly.

### DRAWINGS

Preferred exemplary embodiments will hereinafter be described in conjunction with the appended drawings, wherein like designations denote like elements, and wherein:

FIG. 1 is an exploded view of an exemplary steering knuckle assembly, along with other adjoining parts;

FIG. 2A is a perspective view of a portion of a steering knuckle assembly before a bearing assembly is installed in a reinforcing insert;

FIG. 2B is a cross-sectional view of the steering knuckle assembly of FIG. 2A taken along lines 2B;

FIG. 3 includes perspective views of several different reinforcing inserts that may be part of the steering knuckle assembly of FIGS. 1 and 2A;

FIG. 4A is a perspective view of a portion of another steering knuckle assembly before a bearing assembly is installed in a reinforcing insert, in this embodiment the reinforcing insert has a square shaped outer perimeter;

FIG. 4B is a cross-sectional view of the steering knuckle assembly of FIG. 4A taken along lines 4B;

FIG. 5A is a perspective view of a portion of another steering knuckle assembly before a bearing assembly is installed in a reinforcing insert, in this embodiment an opening in the center of the reinforcing insert must first be machined before the bearing assembly can be installed;

FIG. 5B is a cross-sectional view of the steering knuckle assembly of FIG. 5A taken along lines 5B;

FIG. 6A is a perspective view of a portion of yet another steering knuckle assembly before a bearing assembly is installed in a reinforcing insert, in this embodiment the reinforcing insert itself acts as one of the bearing races;

FIG. 6B is a cross-sectional view of the steering knuckle assembly of FIG. 6A taken along lines 6B; and

FIG. 7 is a flowchart showing some of the steps of an exemplary embodiment of a manufacturing method that may be used to produce the present steering knuckle assembly.

### DETAILED DESCRIPTION

A steering knuckle is a vehicle component that holds a wheel hub or spindle and is attached to various parts of the vehicle suspension and steering systems. More specifically, a steering knuckle rotatably holds a wheel hub or spindle and is typically connected to upper and lower control arms via corresponding ball joints, as well as a tie rod or other steering linkage. During manufacture of a steering knuckle assembly, a wheel bearing is sometimes press fit into an opening located towards the center of the steering knuckle. This press fitting may induce or otherwise result in hoop stresses, circumferential stresses, radial stresses and/or other types of stresses on the components involved (hereafter collectively referred to as ‘induced stresses’). Materials such as cast iron and steel are typically strong enough to withstand the induced stresses, however, they are quite heavy and can negatively impact the fuel economy of the vehicle. Lighter materials, like those based on aluminum, may not be strong enough on their own to withstand the induced forces and can crack or rupture upon press fitting the wheel bearing. The steering knuckle described herein is made from a lightweight material, such as an aluminum-based material, that is over-molded or cast around a reinforcing insert with an opening for receiving a press fit wheel bearing assembly. Therefore, the present steering knuckle assembly is lightweight, it uses an easy to manufacture press fitting for the wheel bearing, and it includes a reinforcing insert that is strong enough to withstand the various induced stresses.

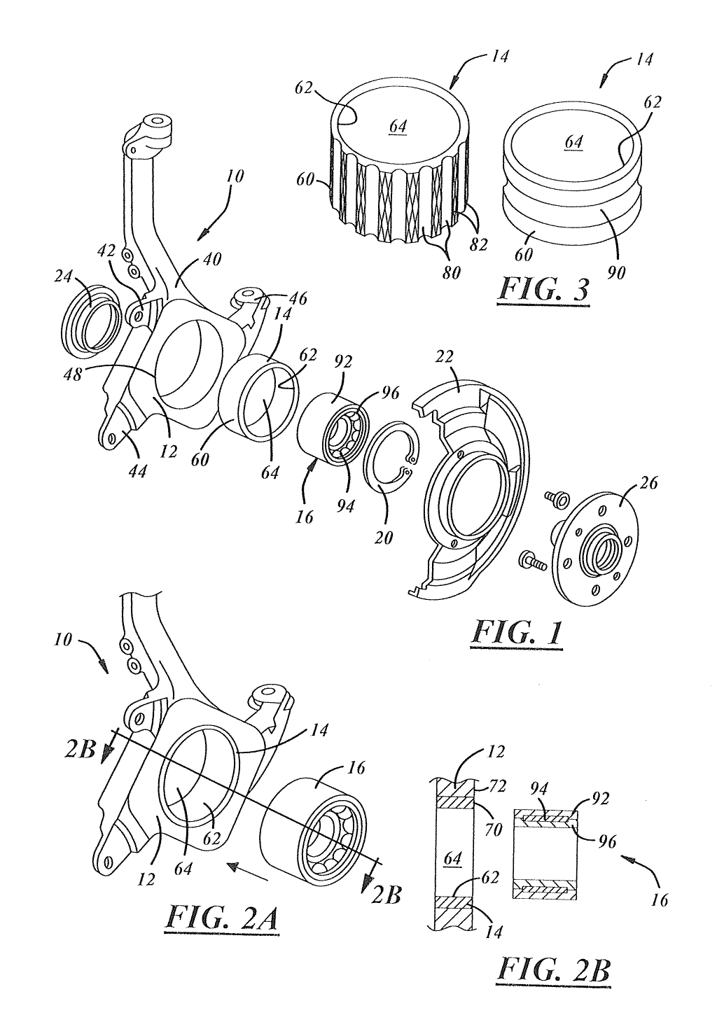

Turning now to FIG. 1, there is shown an exploded view of an exemplary steering knuckle assembly 10, along with some other adjoining parts. The steering knuckle assembly 10 generally includes a steering knuckle component 12, a reinforcing insert 14, and a wheel bearing assembly 16. Other components shown in FIG. 1, but that are not necessarily part of the steering knuckle assembly, include a snap ring 20 for further securing the wheel bearing assembly in place, dust covers 22 and 24 for shielding the wheel bearing assembly from dirt, water and other debris, and a wheel hub 26. The steering knuckle assembly 10 can be used in a wide range of applications, including vehicles such as automobiles, trucks, sports utility vehicles (SUVs), cross-over vehicles, all terrain vehicles (ATVs), recreational vehicles (RVs), farm equipment, aviation equipment, and construction equipment, to name but a few examples.

Steering knuckle component 12 is designed to rotatably hold the wheel hub 26 while connecting to various components of the vehicle suspension and steering systems. According to the particular embodiment shown here, the steering knuckle component 12 has a multi-lobed configuration and includes a body portion 40, attachment portions 42, 44, 46, and an insert opening 48. Of course, other shapes, sizes, and configurations are certainly possible depending on the particular vehicle in which the steering knuckle component is used, as the drawing in FIG. 1 is simply meant to illustrate one possibility. It should be appreciated that in the exploded view of FIG. 1, the reinforcing insert 14 is not yet formed or embedded within the steering knuckle component 12, but is shown in a pre-formed or removed state in order to better illustrate some of the features of that component; in the corresponding perspective view of FIG. 2A (which is the same embodiment as FIG. 1), the reinforcing insert has already been formed within the steering knuckle component.

The body portion 40 makes up the majority of the steering knuckle component 12 and is designed to be strong enough to endure not only the induced stresses mentioned above, but also stresses caused by braking, cornering and/or other vehicle operations. The attachment portions 42, 44, 46 all extend from the body portion 40 and are designed to connect with the vehicle suspension or steering systems. For example, attachment portion 42, which can be in the shape of lobe or ear with an opening in the center, is intended to attach to an upper control arm (not shown); attachment portion 44 is designed for attachment to a lower control arm (not shown); and attachment portion 46 is intended for connection with a tie rod or some other linkage (not shown) that is part of the steering system. Attachment portions 42, 44, 46 can be used to attach or connect any suitable combination of suspension, steering or other components, including, but not limited to, control arms, steering arms, tie rods, shock absorbers, struts, ball joints, cams, bushings, bolts, bearings, etc. Insert opening 48 may be located towards the center of the body portion 40, and is sized to accommodate the reinforcing insert 14. In the embodiment of FIGS. 1-2B, the insert opening 48 is formed so that it is generally flush or co-planar with the surrounding body portion 40; in other embodiments, the reinforcing insert 14 may be formed in a raised collar or boss that extends outward from the side surface of the body portion 40. It should be appreciated that the steering knuckle component 12 that is shown in the drawings and is described herein simply represents one possible embodiment of such a component and that the present steering knuckle assembly could just as easily use any number of other steering knuckles, including ones that differ significantly from that shown. The particular shape of the steering knuckle component 12 is not imperative, so long as it includes the reinforcing insert.

The steering knuckle component 12 is preferably made out of a lightweight metal material, such as an aluminum-based material. As used herein, “aluminum-based material” broadly includes pure metals, metal alloys and/or any other materials wherein aluminum (Al) is the single largest constituent of the material on a wt % basis. This includes materials having greater than 50 wt % of aluminum, as well as those materials having less than 50 wt % of aluminum so long as aluminum is the single largest constituent. Some non-limiting examples of possible aluminum-based materials include, but are certainly not limited to, the following aluminum alloys: A356, A365, A367, A380, A383, B390, ADC10, ADC12, Aural-2, Silafont-36, and Catasil-37.

The reinforcing insert 14 is located within the body portion 40 of the steering knuckle component 12 and acts as a strengthened or reinforced sleeve for receiving the wheel bearing assembly 16. As mentioned above, there are a number of stresses (induced stresses and others) that may act upon the steering knuckle assembly 10, particularly in the area of the interface between the steering knuckle assembly 10 and the wheel bearing assembly 16. Aluminum-based materials are typically not strong or robust enough to withstand these forces by themselves, thus, the use of the reinforcing insert 14. According to one embodiment, the reinforcing insert 14 is placed within the mold cavity that is used to cast or otherwise form the steering knuckle component 12 so that the aluminum-based material of the steering knuckle can flow and solidify around the reinforcing insert, thereby locking it in place. A number of suitable processes may be used to perform this over-molding or casting operation, including different types of high pressure die casting (HPDC) and squeeze casting, as will be described below in more detail. In the exemplary embodiment shown in FIGS. 1 and 2, the reinforcing insert 14 is a cylindrical sleeve-like component that includes an outer surface 60, an inner surface 62, and a bearing opening 64. In a different embodiment, the reinforcing insert 14 could be closed on one of its axial ends so that it acts as a cup or pocket for receiving the wheel bearing assembly 16.

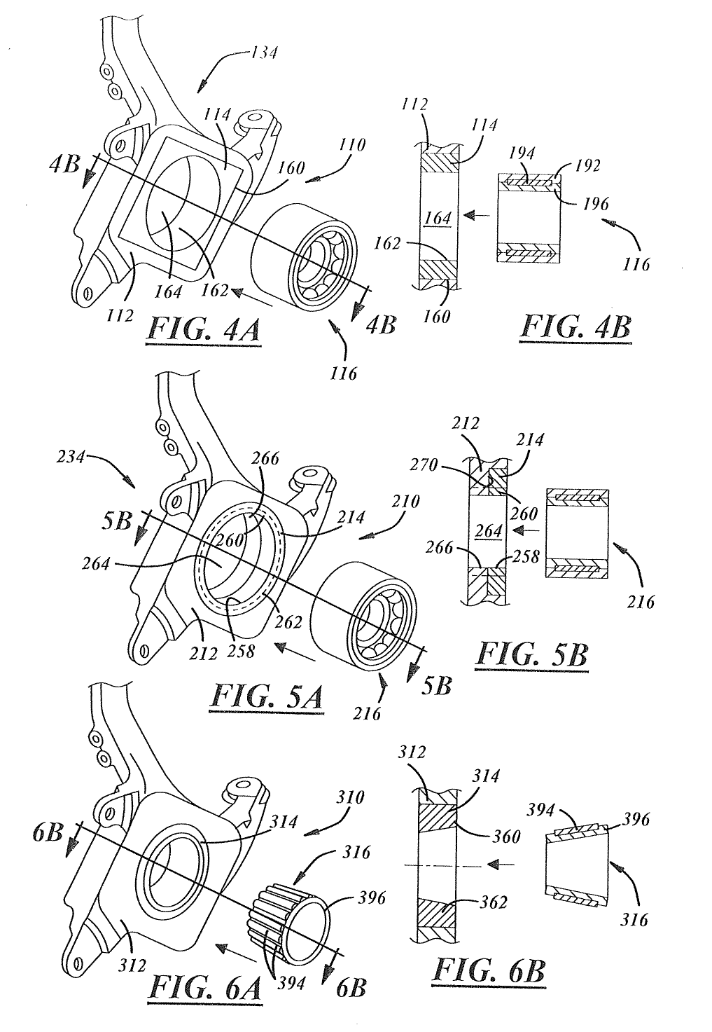

The outer surface 60 is expected to come into contact with and be encased by molten aluminum-based or other material when the steering knuckle component 12 is formed around the reinforcing insert 14. Hence, it may be beneficial to provide the outer surface 60 with one or more interlocking features that promote bonding or attachment between the reinforcing insert 14 and the steering knuckle component 12. Some examples of such interlocking features are shown in FIG. 3, including axially extending grooves 80 and textured surface segments 82, as well as circumferentially extending grooves 90. These and other features may be provided to promote mechanical, molecular and/or other types of bonding between the reinforcing insert 14, which is already solid and intact when it is inserted into the mold cavity, and the molten lightweight material of the steering knuckle component 12. It should be appreciated that any combination of interlocking features may be used, including grooves, channels, ribs, tabs, flanges, pockets, as well as different types of textured, knurled or other surface features. Furthermore, the reinforcing insert 14 need not be perfectly cylindrical, so long as the inner surface 62 is adapted to securely receive the appropriate wheel bearing assembly 16. One example of this is schematically shown in FIG. 4A, where the outer surface or perimeter of the reinforcing insert is square shaped, as opposed to being circular. Other embodiments and designs are certainly possible.

The inner surface 62, on the other hand, is designed to securely receive the wheel bearing assembly 16, which may be press-fit, maintained in place by snap ring 20, or by some other suitable means known in the art. The inner surface 62 of the reinforcing insert 14 forms a contact surface for the wheel bearing assembly 16 so that when the wheel bearing is installed in the steering knuckle assembly, an outer surface of the wheel bearing comes into intimate contact with the inner surface 62 of the insert. In one embodiment, the outer surface of the wheel bearing is a cylindrical surface that is slightly larger the corresponding cylindrical inner surface 62; this creates a press fit or interference fit between the two components. Arranging the reinforcing insert 14 within the steering knuckle component 12 so that its inner surface 62 is exposed to and acts as a contact surface for the wheel bearing assembly 16 can greatly strengthen the steering knuckle assembly 10 in the area of the opening 48 and help protect the assembly from the induced stresses that oftentimes occur during press fit installation. Stated differently, the reinforcing insert 14 with its inner surface 62 acting as a direct contact surface for the wheel bearing assembly 16 provides a circumferential support or brace to counteract the hoop or circumferential stresses caused during a press fit installation of the wheel bearing. The exact size, shape and configuration of the inner surface 62 of the reinforcing insert is largely dictated by the particular wheel bearing assembly 16 that is being installed and does not necessarily have to be a smooth cylindrical surface, although it can be.

The bearing opening 64 is formed in one or both of the axial ends of the reinforcing insert 14 and, like the inner surface 62, it is sized and shaped to receive the wheel bearing assembly 16. The insert opening 48 and the bearing opening 64 may be concentric or co-axial, but this is not required. In the embodiment illustrated in FIGS. 2A-B, the reinforcing insert 14 is embedded within the steering knuckle component 12 such that an axial surface 70 of the insert is flush with an adjacent side surface 72 of the steering knuckle. This is not required, however, as the axial surface 70 of the reinforcing insert 14 could be raised from the adjacent surface 72 in the form of a collar or boss that extends away from the rest of the steering knuckle component 12 and provides additional support for the wheel bearing assembly 16. In yet another embodiment, the reinforcing insert 14 could be recessed within the steering knuckle component 12 so that the axial surface 70 is set back compared to side surface 72. These are only some of the possible arrangements or configurations for the reinforcing insert 14, as others are certainly possible.

The reinforcing insert 14 is preferably made from a strengthened material that is harder or stronger than the lightweight material used to make the steering knuckle component 12 and that is capable of withstanding the induced stresses and other forces involved. As used herein in the context of metal materials, the term “lighter” means that one metal material has a lower density (mass/unit volume) than another metal material, and the term “harder” means that one metal material has a higher surface hardness than another metal material. According to one exemplary embodiment, the reinforcing insert 14 is made from a strengthened ferrous-based material, such as cast or forged iron or steel, and the steering knuckle component 12 is made from a lightweight aluminum-based material. However, other material choices are certainly possible.

The wheel bearing assembly 16 allows a vehicle wheel to spin with minimal wear and friction, as is widely known and understood in the art, and may include an outer race 92, rolling elements 94, and an inner race 96. According to the particular embodiments shown here, the wheel bearing assembly or bearing housing 16 is securely inserted into the reinforcing insert 14 (e.g., via a press-fit arrangement) so that an outer surface of the outer race 92 contacts the inner surface 62 of the reinforcing insert. The rolling elements 94 roll between the inner and outer races 96 and 92 and may include ball bearings, roller bearings, roller thrust bearings, or tapered roller thrust bearings, or any other suitable bearing type known in the art. Use of other bearing components, bearing configurations and bearing arrangements, as well as snap rings or other parts, is certainly possible. Because the present steering knuckle assembly 10 may be used with any suitable type of wheel bearing and because wheel bearings are so widely known in the art, a further discussion of how wheel bearings work and are connected to the wheel hub 26, as well as other potential components, has been omitted.

Turning now to FIGS. 4A and 4B, there is shown a schematic illustration of a different exemplary embodiment of a steering knuckle assembly 110, prior to a wheel bearing assembly 116 being press-fit or otherwise installed in a reinforcing insert 114 so as to form a completed assembly. As with the previously described embodiments, the steering knuckle assembly 110 includes a steering knuckle component 112, a reinforcing insert 114, and a wheel bearing assembly 116. In this particular example, the reinforcing insert 114, which has a square shaped outer surface or perimeter 160 and a cylindrical shaped inner surface 162, has already been integrally formed with the steering knuckle component 112 to form a composite or unitary steering knuckle component 134. Instead of a square shaped outer surface 160, other non-cylindrical shapes that prevent the reinforcing insert from turning or rotating in the steering knuckle component could be used as well. Following formation of the composite steering knuckle component 134, the wheel bearing assembly 116 with its outer race 192, rolling elements 194, and inner race 196 is press-fit or otherwise secured in the bearing opening 164 so that the bearings are generally surrounded by the reinforcing insert 114. Any suitable technique or method for inserting the wheel bearing assembly 116 may be employed. In this particular embodiment, when the steering knuckle component 112 is cast and formed around the reinforcing insert 114, the insert has an inner surface 162 that is already machined, cut, ground and/or otherwise formed to the correct size and shape for receiving the wheel bearing assembly 116.

FIGS. 5A and 5B show a steering knuckle assembly 210 that is similar to that of FIGS. 4A and 4B, except that when the reinforcing insert 214 is integrally formed within the steering knuckle component 212, the initial inner surface 258 (solid line) of the reinforcing insert has not yet been machined to its final dimensions which correspond to inner surface 262 (dashed line). As illustrated in FIGS. 5A and 5B, the initial inner surface 258 defines a bearing opening that is too small to accommodate the wheel bearing assembly 216, thus, the opening is machined, ground, cut and/or otherwise expanded before the wheel bearings are installed by forming a subsequent inner surface 262. The section of material that is removed is referred to as the machined or removed area 260. By machining, grinding, cutting and/or otherwise removing the machined area 260 after the casting or forming process, a more precise fit for wheel bearing assembly 216 may be obtained. This may be helpful in situations where, during the formation of the composite steering knuckle component 234, the reinforcing insert 214 becomes slightly warped, deformed or otherwise misshapen. Controlled machining may rid the reinforcing insert 214 of any such deformities, thereby providing a tighter, more accurate interface for wheel bearing assembly 216. Some non-limiting examples of possible machining or cutting processes include electrical discharge machining (EDM), laser cutting, or water jet cutting.

In FIG. 5B, the reinforcing insert 214 is a ring-shaped component that is seated on an annular shoulder 270 of the steering knuckle component 212 in the area of bearing opening 264. Accordingly, the initial inner surface 258 of the reinforcing insert 214 will be machined at the same time as an adjacent inner surface 266 of the steering knuckle component 212 so as to form a unitary or continuous inner cylindrical surface for receiving the wheel bearing assembly 216, where the unitary surface is flush and smooth across the interface between the two components. This type of shoulder seating arrangement is optional, as it is also possible for the insert 214 to have a greater axial extent such that it extends across the entire thickness of the steering knuckle component 212, as shown in FIGS. 2B and 4B of the prior embodiments. The annular shoulder 270 in the steering knuckle component 212 may be advantageous during a press fit installation of the wheel bearing assembly 216 to ensure that the reinforcing insert 214 is properly maintained in place and not pushed out of the back of the steering knuckle. In a different embodiment, the reinforcing insert has the annular shoulder, instead of the steering knuckle component.

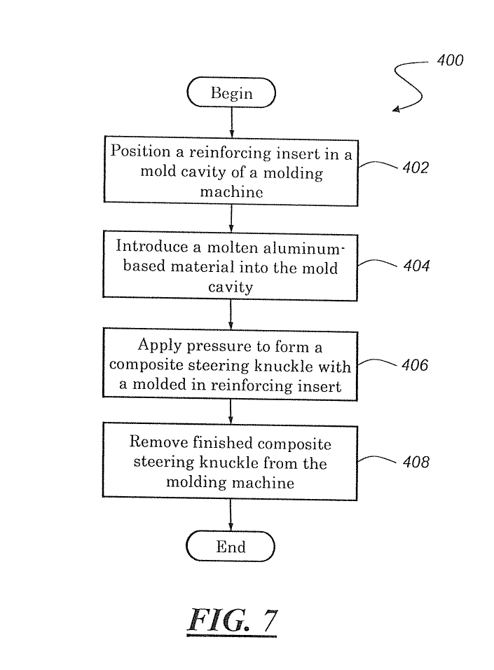

FIGS. 6A and 6B show yet another example of a steering knuckle assembly 310 that is similar to those described above, except that the reinforcing insert 314 is provided in a manner where it acts as the outer race for the wheel bearing assembly 316. More specifically, the reinforcing insert 314 is integrally formed with the steering knuckle component 312 in much the same way as has already been explained, but after the casting process a portion of the reinforcing insert is machined or ground down so that the inner surface 362 actually becomes the outer race for the rolling elements 394. The process of converting a surface of the reinforcing insert 314 into a bearing race requires a certain amount of precision and may entail removing a machined area 360 from the insert. The newly created outer race surface 362 may be angled or tapered (as shown), it may be straight, or it may be provided according to some other suitable bearing arrangement. To finish assembling the steering knuckle assembly 310, it is necessary to press-fit or otherwise install a partial wheel bearing assembly 316 (e.g., one having an inner race 396 and rolling elements 394) into the bearing opening, as the outer race is already in place via the inner surface 362 of the reinforcing insert 314.

It should be appreciated that the steering knuckle assembly embodiments shown in the drawings and described above only represent some of the possible configurations and that other configurations and arrangements could certainly be used instead. Moreover, any of the features shown or described in conjunction with any of the preceding embodiments, may be employed in the other embodiment as well.

Turning now to FIG. 7, there is shown a flowchart that outlines some of the potential steps of an exemplary manufacturing method 400 for forming a steering knuckle assembly, such as those described above. Although method 400 is described with relation to the steering knuckle assembly 10 shown in FIG. 1, it is also applicable to the other steering knuckle assemblies depicted in FIGS. 2A-6B. As will be appreciated by those skilled in the art, the exact number of steps, the order of steps, the operating parameters of each step, and the operations performed within each step can be dictated by factors such as the shape and specifications of the particular steering knuckle being produced and the particular type of casting machinery or equipment being used; thus, the details provided below are simply provided as non-limiting examples. According to one exemplary embodiment, the manufacturing method 400 generally includes steps for: positioning a reinforcing insert in a mold cavity, introducing a molten aluminum-based material into the mold cavity, applying pressure to form a composite steering knuckle component with a molded-in reinforcing insert, removing the finished composite steering knuckle component from the mold cavity, and installing the wheel bearing assembly into the reinforcing insert.

In step 402, the reinforcing insert 14 is positioned in a mold cavity of a die casting machine. The die casting machine may vary depending on the particular casting method being used, however, some examples of potential methods include conventional aluminum die casting, high pressure die casting (HPDC), and squeeze casting (e.g., high-vacuum or vacuum-assist squeeze casting). Squeeze casting, for example, can combine some of the advantages of high pressure die casting (HPDC) and low pressure casting to provide net or near net-shape fabrication with high integrity and minimal shrinkage porosity. Furthermore, a composite steering knuckle formed by squeeze casting may have a more fine-grained, uniform microstructure with improved surface finish than those formed by comparable processes. Step 402 can be performed in a number of ways including automatically loading the reinforcing insert 14 with a robotic arm or other automated device, or manually loading the structural insert into the mold cavity. Reinforcing insert 14 may be properly oriented and held in place by structural features in the die casting machine itself, clamps, magnets, suction devices, gravity, or any other suitable means known in the art. The particulars of this step may be dictated by, among other things, the orientation of the die casting machine (horizontal, vertical, etc.) and the type of die casting machine being used (hydraulic, electric, hybrid, etc.). Step 402 may further include the step of coating the reinforcing insert 14 with a surface treatment or a reactive coating to chemically enhance the bond between the outer surface of the insert and the aluminum-based material flowing around it. Step 402 may also include coating the mold cavities with a lubrication medium to assist in later removal steps, including but not limited to, PTFEs or other graphite-based mediums, for example.

In step 404, a molten lightweight material, such as an aluminum-based material, is introduced into the mold cavity. Process parameters, like die temperature and pouring temperature should be adjusted to the particular process and component being formed, and may be dependent upon qualities of the aluminum-based material used such as melting temperature and thermal conductivity. Further, the amount of aluminum-based material will vary depending on the specifications of the desired steering knuckle component. Some potential benefits of using a squeeze casting process or the like is that it can result in a component or part with little to no “skin effect,” a rather uniform microstructure, and reduced gas and shrink porosity which, in turn, can improve part integrity.

Next, an appropriate amount of pressure is applied so that the steering knuckle component can form around the reinforcing insert, step 406. Again, the application of pressure will vary depending on the particular casting or other method being used, which may include conventional aluminum die casting, high pressure die casting (HPDC), or squeeze casting, to cite a few examples. Controlled mold cavity filling and pressure application during a squeeze casting method, for example, may assist in preventing the entrapment of gasses in the finished composite steering knuckle. The timing and amount of pressure applied will also vary depending on the particular application. This process is sometimes referred to in the present application as “over-molding,” even though it involves casting molten metal, as opposed to molding plastic. After step 406 is completed and the aluminum-based or other lightweight material has properly solidified, a composite steering knuckle component is fashioned with the reinforcing insert integrally formed within the steering knuckle component.

In step 408, the finished composite steering knuckle component can be removed from the die casting machine. The removal process can be performed in a number of ways including, for example, through automated means involving a robot, a part picker, or a part ejection mechanism, or with manual labor. As previously described, additional processing steps may include press fitting or otherwise installing a wheel bearing assembly or partial bearing assembly into the composite steering knuckle component. Press fitting the wheel bearing assembly or partial bearing may take place before or after an additional possible step of machining the reinforcing insert. Furthermore, press fitting the wheel bearing assembly can be less laborious and time consuming than other mounting methods, such as bolting the wheel bearing housing on, which is oftentimes the case with forged aluminum steering knuckles.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A steering knuckle assembly for a vehicle, comprising:
a steering knuckle component that is made of a first metal material and has a body portion and one or more attachment portions; and
a reinforcing insert that is made of a second metal material and has an outer surface, an inner surface and a bearing opening, the first metal material is lighter than the second metal material and the second metal material is harder than the first metal material;
wherein the steering knuckle component is at least partially formed around the reinforcing insert so that the outer surface of the reinforcing insert is encased in the first metal material and the inner surface of the reinforcing insert surrounds the bearing opening and forms a contact surface for a wheel bearing assembly.

2. The steering knuckle assembly of claim 1, wherein the steering knuckle component has an insert opening for accommodating the reinforcing insert located towards a center of the body portion, and the one or more attachment portions are configured to connect with one or more components of a suspension system, a steering system, or both.

3. The steering knuckle assembly of claim 1, wherein the reinforcing insert is a cylindrical sleeve-like component where the outer surface is a cylindrical surface encased in the first metal material and the inner surface is a cylindrical surface that is sized and shaped to create an interference fit with a wheel bearing assembly.

4. The steering knuckle assembly of claim 1, wherein the reinforcing insert is a bushing-like component where the outer surface is a non-cylindrical surface encased in the first metal material and the inner surface is a cylindrical surface that is sized and shaped to create an interference fit with a wheel bearing assembly.

5. The steering knuckle assembly of claim 1, wherein the reinforcing insert is a cup-like component closed on one axial end where the inner surface and closed axial end are sized and shaped to secure receive a wheel bearing assembly.

6. The steering knuckle assembly of claim 1, wherein the reinforcing insert is an annular component that completely surrounds the bearing opening in the form of a circumferential support and is made of a strengthened metal material designed to withstand induced stresses caused by press fitting a wheel bearing assembly in the bearing opening.

7. The steering knuckle assembly of claim 1, wherein the outer surface of the reinforcing insert has interlocking features that promote mechanical bonding between the reinforcing insert and the steering knuckle component when the steering knuckle component is at least partially formed around the reinforcing insert.

8. The steering knuckle component of claim 5, wherein the interlocking features include one or more grooves or channels formed into the outer surface of the reinforcing insert.

9. The steering knuckle assembly of claim 1, wherein the reinforcing insert is embedded within the steering knuckle component so that an axial surface of the reinforcing insert is flush with an adjacent side surface of the steering knuckle component.

10. The steering knuckle assembly of claim 1, wherein the reinforcing insert is partially embedded within the steering knuckle component so that an axial surface of the reinforcing insert extends away from an adjacent side surface of the steering knuckle component to form a collar.

11. The steering knuckle assembly of claim 1, wherein the inner surface of the reinforcing insert is machined, ground or cut after the steering knuckle component is at least partially formed around the reinforcing insert.

12. The steering knuckle assembly of claim 11, wherein the reinforcing insert is seated on an annular shoulder of the steering knuckle component and the inner surface of the reinforcing insert is machined, ground or cut at the same time as an adjacent inner surface of the steering knuckle component so as to form a unitary inner cylindrical surface for receiving the wheel bearing assembly.

13. The steering knuckle assembly of claim 1, wherein the inner surface of the reinforcing insert at least partially constitutes an outer race of the wheel bearing assembly and provides a contact surface for a plurality of rolling elements.

14. The steering knuckle assembly of claim 13, wherein the inner surface of the reinforcing insert that at least partially constitutes an outer race of the wheel bearing assembly is angled so that it is not parallel to a center axis (A) of the reinforcing insert.

15. The steering knuckle assembly of claim 1, wherein the steering knuckle component is made of an aluminum-based material and the reinforcing insert is made of a ferrous-based material.

16. The steering knuckle assembly of claim 1, wherein the steering knuckle component is a squeeze cast component that is at least partially formed around the reinforcing insert.

17. The steering knuckle assembly of claim 1, further comprising a wheel bearing assembly installed in the bearing opening of the reinforcing insert.

18. A method of forming a steering knuckle assembly for a vehicle, comprising the steps of:
positioning a reinforcing insert within a mold cavity of a die casting machine;
introducing a molten aluminum-based material into the mold cavity of the die casting machine so that the molten material at least partially surrounds the reinforcing insert;
applying pressure with the die casting machine to form a composite steering knuckle component with the integrally formed reinforcing insert; and
removing the composite steering knuckle component from the die casting machine, wherein the integrally formed reinforcing insert includes an inner surface for receiving a wheel bearing assembly.

19. The method of claim 18, wherein the introducing a molten aluminum-based material step and the applying pressure step are part of a squeeze-casting manufacturing process.
